(19) United States
(12) Patent Application Publication
(10) Pub. No.: US 2023/0390827 A1
(43) Pub. Date: Dec. 7, 2023

(54) APPARATUS FOR CHAMFERING PIPE END

(71) Applicant: Kuri Technologies Oy, Kokkola (FI)

(72) Inventors: Kai Risto Matias KAKKURI, Kokkola (FI); Antti Matias KAKKURI, Kokkola (FI)

(21) Appl. No.: 18/249,861

(22) PCT Filed: Oct. 1, 2021
(86) PCT No.: PCT/FI2021/050648

§ 371 Date: Apr. 20, 2023

(30) Foreign Application Priority Data
Oct. 23, 2020 (FI) U20204139
Mar. 19, 2021 (FI) 20215303

(51) Int. Cl. B23B 5/16; B26D 3/16

(52) U.S. Cl. CPC B23B 5/167; B26D 3/166; B23B 2226/61

(57) ABSTRACT

In the disclosed solution, a device for chamfering a pipe (1) end has a body part (6) having means for fastening it to an adapter (9) to be placed in a chuck of a handheld drill. The body part (6) further has at least two formed parts such as pins (7), facing forward from the body part (6) and adaptable to settle inside the pipe (1) to be chamfered. On the outer rim of the body part (6), there are chamfering means to chamfer the outer edge of the end of the pipe (1).

### BACKGROUND OF THE INVENTION

The invention relates to chamfering a pipe end and, in particular, to chamfering a plastic pipe end.

For example, when installing sewer pipes, it is worth forming a chamfer in the pipe before the pipe is installed in a sleeve or another joint. Forming a chamfer with a knife, for example, is difficult and laborious under construction site conditions, in particular, and the outcome is uncertain. On the other hand, devices for chamfers are typically complex, cumbersome; and expensive.

### BRIEF DESCRIPTION OF THE INVENTION

It is therefore an object of the invention to develop a novel device for chamfering a pipe end. The solution according to the invention is characterised by what is disclosed in the independent claims. Some embodiments of the invention are disclosed in the dependent claims.

In the disclosed solution, the device for chamfering a pipe end has a flat body part having means for fastening it to an adapter to be placed in a chuck of a handheld drill. The body part may be a plate. The body part further has at least two formed parts such as pins, facing forward from the body part and adaptable to settle inside a pipe to be chamfered. The outer rim of the body part has chamfering means to chamfer the outer edge of a pipe end. Such a device is simple and easy to use under construction site conditions, too. The device can be made fairly short, A chamfer on the outer edge of a pipe can be easily and reliably accomplished. It is in fact possible to make a chamfer corresponding to a factory-made chamfer on a cut pipe. This guarantees a flawless and more occupationally safe installation. Due to chamfering, the popping out of a seal may be avoided when a pipe is being installed in a sleeved pipe or a sleeved pipe part having a seal. All in all, a chamfer may be made safely with the device, and due to the forming of a chamfer a pipe is faster to install, and the overall work quality is very good.

According to an embodiment, the chamfering means comprise saw blade teeth adapted in a forward slanting position from the body part. Such a structure is effective and reliable.

According to an embodiment, the chamfering means comprise a slanting rim formed on the outer rim of the round body part and adapted forward from the body part as well as having a surface that machines the pipe formed on its surface. The surface that machines the pipe may comprise, for example, protrusions, grooves and/or a roughening. Such a structure is simple, durable, and practical.

According to an embodiment, the body part has at least three, advantageously at least four, formed parts facing forward from the body part and adaptable to settle inside a pipe being chamfered. This way, the pipe being chamfered can be aligned to settle centrally in relation to the device. Consequently, the chamfer can be formed reliably and with precision in connection with the outer edge of a pipe end.

According to an embodiment, the formed parts are so formed that when the device is in use they remove burrs from the pipe end. The formed parts may be adapted on the body part so that the distance of the outer edge of the formed part from the middle of the body part corresponds to the radius of the inner surface of the pipe being handled or is only slightly smaller than it. When the device is being used, the formed part thus slides along the inner surface of the pipe or is at least so close to the inner surface of the pipe that it removes burrs from the inner edge of pipe end. The formed part may have, for example, a sharp edge that removes burrs. This means that the device is able to make a chamfer at the pipe end and the pipe end can at the same time be made tidy for installation.

### BRIEF DESCRIPTION OF THE DRAWINGS

The invention is now described in closer detail in connection with some embodiments and with reference to the accompanying drawings, in which:

FIG. 1a shows a pipe end cut off by sawing;

FIG. 1b shows the pipe end of FIG. 1a, with a chamfer formed thereto;

FIG. 2 is a schematic side view of a device for chamfering a pipe end;

FIG. 3 is a schematic front diagonal view of the device of FIG. 2;

FIG. 4 is a schematic front diagonal view from below of a second device for chamfering a pipe end;

FIG. 5 is a schematic front diagonal view from above of a third device for chamfering a pipe end;

FIG. 6 is a schematic view of a second embodiment for a chamfering device according to the solution of FIG. 5;

FIG. 7 is a schematic front diagonal view from above of a fourth device for chamfering a pipe end;

FIG. 8 is a schematic rear view of the device of FIG. 7;

FIG. 9 is a schematic side view of the device of FIG. 7;

FIG. 10 is a schematic view of a second embodiment of the chamfering means and formed parts according to the solution of FIG. 7;

FIG. 11 is a schematic front diagonal view from above of a fifth device for chamfering a pipe end;

FIG. 12 is a schematic front diagonal view from above of a sixth device for chamfering a pipe end; and

FIG. 13 is a schematic front diagonal view from above of a protective cup.

### DETAILED DESCRIPTION

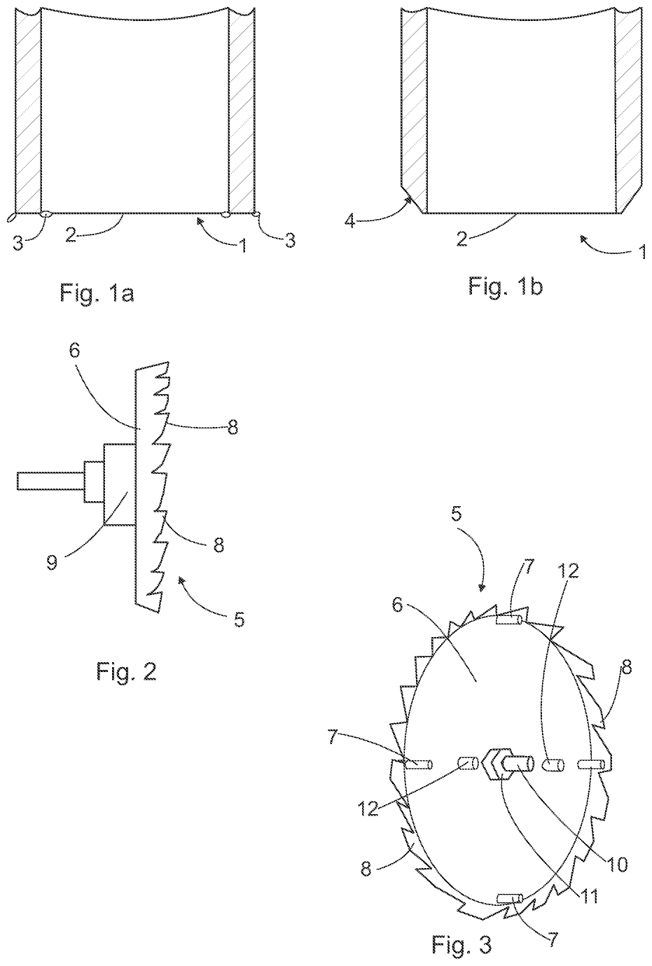

FIG. 1a shows a pipe 1 as seen from a side and in cross section. The pipe 1 may be, for example, a plastic pipe made, for example, of polyethylene PE, polypropylene PP, or crosslinked polyethylene PEX. The pipe 1 may be, for example, a so-called HTP sewer pipe or Decibel sewer pipe. The outer diameter of the pipe 1 may range between 20 and 500 mm, for example.

In the embodiment of FIG. 1a, an end 2 of the pipe 1 is cut off by sawing. The end 2 of the pipe 1 is, after its cutting, for example, such that the wall of the pipe end has the same thickness up to the end 2 of the pipe 1. Further, sawing causes burrs 3 to form at the end 2 of the pipe 1. So, burrs 3 are caused as a result of sawing, and they may be pieces or shreds of the pipe or roughness.

For the end 2 of the pipe 1 to be reasonably easily installed inside a second pipe, a hole made in a second pipe, a connecting sleeve or another similar connecting piece, a chamfer 4 is formed at the end 2 of the pipe 1, as shown in FIG. 1b. Forming the chamfer 4 naturally removes burrs 3 from the outer edge of the end 2 of the pipe 1. In the embodiment of FIG. 1b, the burrs 3 have also been removed from the inner edge of the end 2 of the pipe 1. In accordance with an embodiment of the device 5 set forth in this description, the use of the device for forming a chamfer 4 at the same time removes burrs 3 from the inner edge of the end 2 of the pipe 1.

The chamfer 4 is formed on the outer edge of the end 2 of the pipe 1. Forming a chamfer at a pipe end is referred to as chamfering, bevelling, or a chamfer. The procedure in question is also called shaving.

FIGS. 2 and 3 show a device 5 for chamfering the end 2 of the pipe 1. The device 5 has a round and flat body part 6, The outer diameter of the body part 6 may be slightly larger than the outer diameter of the pipe 1 for whose chamfering the device is meant to be used.

On the front surface of the body part 6, pins 7 have been adapted. The front surface of the body part 6 is the surface which is set towards the end 2 of the pipe 1 when the device 5 is being used. When the pins 7 are on the front surface of the body part 6, in other words located forward-facing from the body part 6, the pins 7 are placed on the inner side of the end 2 of the pipe 1 when the device 5 is used. The pins 7 are adapted at such a distance from the centre point of the body part 6 that they rest on the inner surface of the pipe 1 and thereby centre the device in relation to the pipe 1. This way, the chamfer 4 can be formed symmetrically on the outer edge of the end 2 of the pipe 1. For centring, there needs to be at least two pins 7. If there are three pins 7, the device 5 may be centred even more reliably, and the reliability is further improved if there are four pins 7. If so desired, it is possible to adapt also more than four pins 7 on the front surface of the body part 6.

The body part 6 may be of metal such as steel. The pins 7, too, may be of metal. The pins 7 may be adapted on the body part 6 by welding or riveting, for example.

The pins 7 form the formed parts facing forward from the body part and centring the device 5 in relation to the pipe 1. In the embodiments shown by the figures, the formed parts are round pins 7. The formed parts may also have a different shape, if so required, such as angular or they may be provided with a narrow or sharp shape on their outer edge.

When the device 5 is used, the formed parts may be adapted to remove burrs 3 from the end 2 of the pipe 1, in particular from the inner surface of the pipe 1. The formed parts may be adapted on the body part so that the distance of the outer edge of the formed part from the middle of the body part 6 corresponds to the radius of the inner surface of the pipe 1 being handled or is only slightly smaller than it. This way, when the device 5 is used the formed part slides along the inner surface of the pipe 1, or at least is so close to the inner surface of the pipe 1 that it removes burrs 3 from the end 2 of the pipe 1 on its inner surface.

On the outer rim of the body part 6, there are chamfering means to chamfer the outer edge of the end 2 of the pipe 1. In the embodiment of FIGS. 2 and 3, the chamfering means comprise saw blade teeth 8 adapted in a forward slanting position from the body part 6. The saw blade teeth 8 have a chamfered and chipping cutting surface that forms the chamfer 4.

In FIGS. 2 and 3, the device 5 is attached by its body part 6 to an adapter 9 to be fitted in a chuck of a handheld drill. The adapter 9 may be, for example, one that has a centre bolt 10 of the adapter, and a nut 11 adapted around the centre bolt 10. The adapter 9 may further have support pins 12 of the adapter.

The device 5 is attached to the adapter 9 so that the centre bolt 10 of the adapter is adapted through a centre hole 13 in the middle of the body part 6, and the body part 6 is tightened in connection with the adapter 9 by means of the nut 11 of the adapter. The support pins 12 of the adapter are adapted through side holes 14 that the body part 6 has. This way the body part 6 remains reliably non-rotatable in relation to the adapter 9.

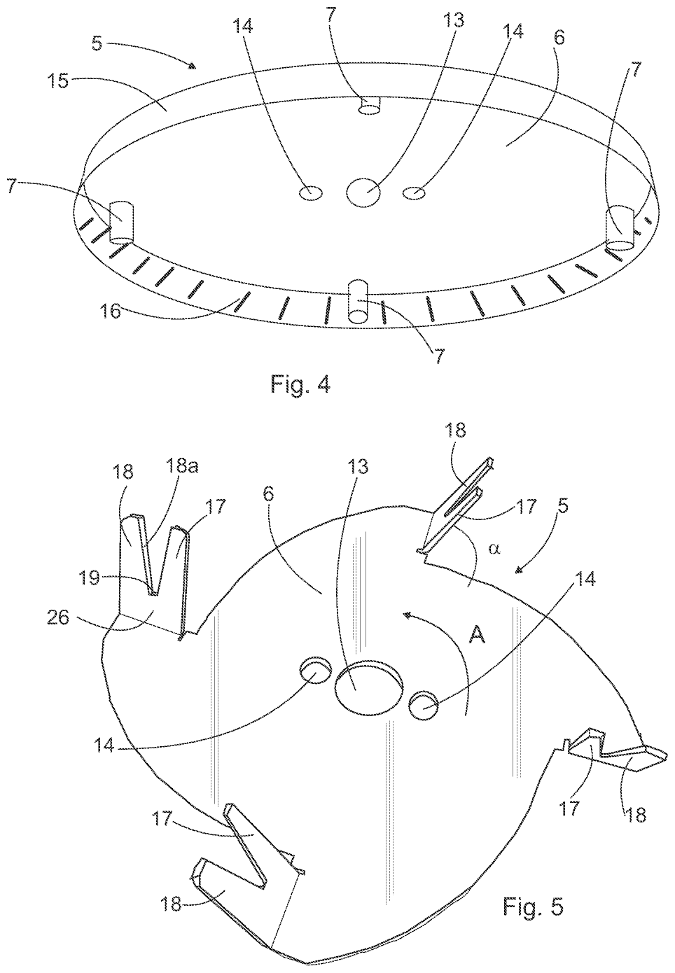

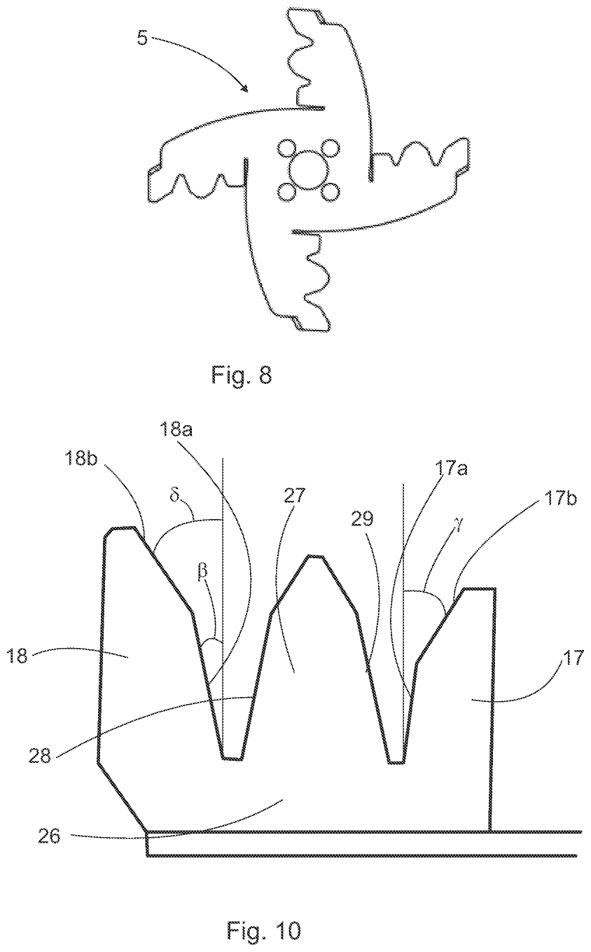

The centre hole 13 and side holes 14 in the body part 6 are presented in connection with the embodiments of FIGS. 4 and 5. In the embodiments seen in FIGS. 2 to 9, the centre hole 13 and side holes 14 form means for fastening the body part 6 to an adapter 9 to be fixed in a chuck of a handheld drill. The centre hole 13 may have a thread. When the body part 6 has means to attach it to an adapter installed in a chuck of a handheld drill, the formed parts placed on the inner surface of the pipe being chamfered are located at a distance from the centre point of the body part 6. In such a case, the inner diameter of the pipe 1 being chamfered may be, for example, at least 50 mm or at least 70 mm. According to an embodiment, the inner diameter of the pipe 1 being chamfered may be within the range from 50 to 500 mm, for example.

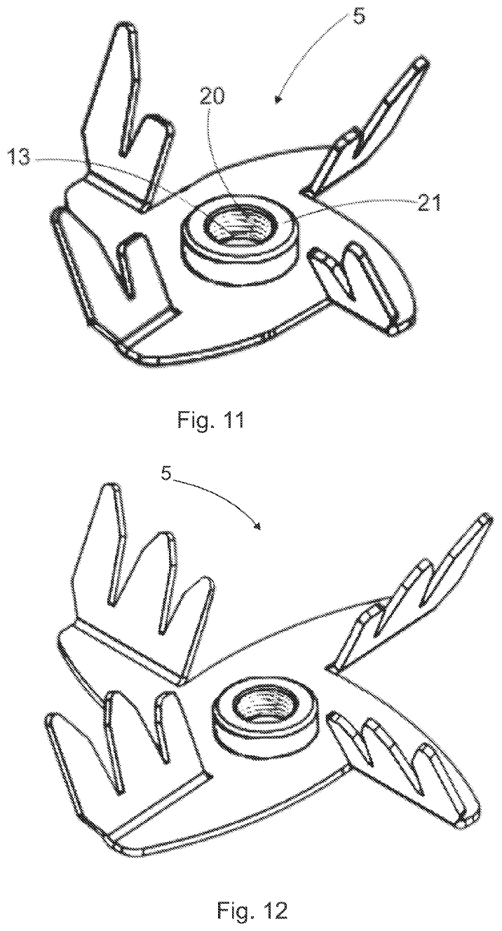

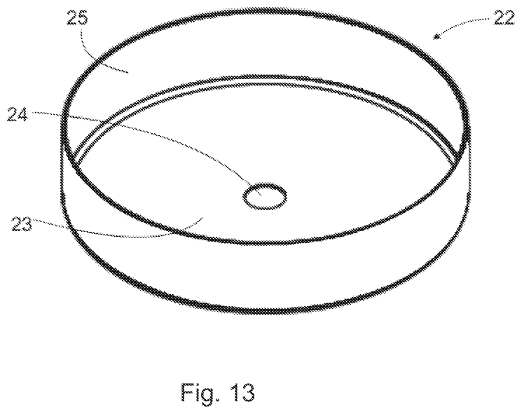

The adapter 9 may also be of another kind than what is described in this context. Similarly, the means for fastening the body part 6 to the adapter may be of a different kind than what is described in this context. The fastening to the adapter may be accomplished without support pins with just a nut. The fastening may make use of nuts of different sizes, and sleeves if need be, and the bolts of the adapter may be extended, if necessary, and so on. Further, the fastening to the adapter may be carried out without support pins and a nut with a mere thread 20 in the centre hole 13. Such a device 5 is shown in FIGS. 11 and 12. As shown in FIGS. 11 and 12, the body part 6 of the device 5 has, in connection with the centre hole 13, a threaded part 21 provided with an inner thread 20. The threaded part 21 may be a protrusion or a nut attached to the body part 6 by welding, for example, So, in this embodiment, the means for attaching the body part 6 to the adapter comprise the thread 20 in the centre hole 13 of the body part 6. The hand of the thread 20 is such that when the chamfer is being formed in the direction of use of the device 5, that is, the rotation direction, the device 5 tightens to the adapter. As a result, the device 5 stays firmly in the adapter and even tightens its connection with the adapter when used. It is hence possible to adapt, for example, a protective cup 22 of FIG. 13 to the adapter. After this, the device 5 is screwed to the centre bolt of the adapter, and the chamfering of the pipe end is commenced. At this time the device and protective cup 22 tighten to the adapter. The protective cup 22 protects the user during use of the device 5.

It is advantageous that the body part 6 is detachably fastenable to the adapter. The body part 6 may also be fixedly adapted to the adapter. It is advantageous that the device 5 is adapted to be used with a handheld tool, such as a drill or the like.

In the embodiment of FIG. 4, on the outer rim of the round body part 6, a slanting rim 15 has been formed, adapted forward from the body part 6. In this manner, the device 5 is formed to have the shape of a dish. On the surface of the slanting rim 15 is formed a surface 16 which machines the pipe. The surface 16 machining the pipe forms chamfering means for chamfering the outer edge of the end 2 of the pipe 1. So, the surface 16 machining the pipe is used to modify the outer edge of the end 2 of the pipe 1 so that a chamfer 4 is formed thereto.

The surface 16 machining the pipe is formed so that when rotated and pressed against the end 2 of the pipe 1, the surface 16 machining the pipe abrades, grinds, and/or roughens the pipe wall so that the chamfer 4 is formed. The surface 16 machining the pipe may have protrusions, grooves and/or a roughening such as a surface resembling sandpaper.

In the embodiment of FIG. 5, the formed parts placed on the inner surface of the pipe 1 being chamfered are plate parts 17 bent forward from a plate-like body blank. The chamfering means, too, are plate parts 18 bent forward from the plate-like body blank. The platelike body blank is a plate in a straight plane. Bending forward refers to bending from the body blank in the direction of the axis of rotation of the device. In such a case, the plate parts 17 and 18, when machining the pipe, are bent from the body part 6 towards the end 2 of the pipe 1 being machined.

The formed part placed on the inner surface and the chamfering means form a structure having the form of the letter V. The outer branch of the letter V, in other words, the plate part 18 is inclined in the lateral direction to the extent of the desired chamfer angle of the chamfer. The inner branch of the letter V, in other words, the plate part. 17 may be straight in the lateral direction, so parallel to the inner surface of the pipe being chamfered. The inner branch of the letter V may also be slightly inclined in the lateral direction so that the branches are easier to place inside the pipe at their tips, and when pushing the device 5 into the pipe 1 the base parts of the branches rest on the inner surface of the pipe and remove burrs 3.

The plate parts 17 and 18 are bent forward from the body blank, but in the embodiments of FIG. 5 the plate parts 17 and 18 are not bent all the way to a right angle, but the plate parts 17 and 18 are bent to a rearward slanting position in relation to a rotational direction A. This way, when the device 5 is being used, both the chamfering means and the formed part placed inside the pipe slide smoothly, that is, do not stick to the pipe at least substantially.

The angle α of the plate parts 17 and 18 in relation to the body part 6 may be between 30 and 89°, for example. Said angle is particularly advantageously between 60 and 70°. In the embodiment of FIG. 5, the plate parts 17 and 18 are bent into the same angle. The chamfering means and formed part may also have different angles. So, the chamfering means may be at the aforementioned angle α and the formed part at a second angle, such as a right angle, in relation to the body part 6.

There may be a gap between the bottom parts of the inner branch of the letter V, that is, the plate part 17, and the outer branch, that is, the plate part 18. In this gap, a smoothing surface 19 may reside, cleaning and smoothing the front edge of the pipe 1 being chamfered.

The plate parts 17 and 18 are bent from the plate-like body blank so that the device 5 has an elastic part 26 located between the plate-like body part 6 and the bases of the plate parts 17 and 18 as well as the smoothing surface 19. The bases of the plate parts 17 and 18 as well as the smoothing surface 19 are therefore located at a distance from the body part 6. Due to the elastic part 26, the body part 6 touching the end of the pipe being chamfered is avoided during chamfering. Also due to the elastic part 26, it is easy to bend the plate parts 17 and 18 into the same angle α, and the plate parts stay reliably at the same angle in relation to each other when the device is used.

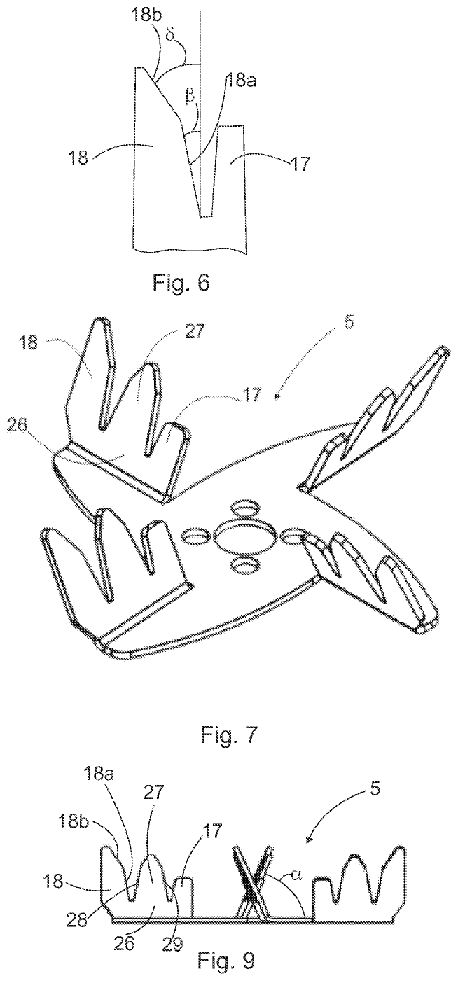

In the embodiment of FIG. 5, the chamfering means and formed part are equally long. The chamfering means and formed part may also have different lengths. The formed part may thus be either longer or shorter than the chamfering means. In the embodiment of FIG. 6, the chamfering means are longer than the formed part. Further in the embodiment of FIG. 6, the chamfering means, that is, the plate part 18, has a machining edge 18a at a chamfering angle β. In addition, the plate part 18 has at its end an outward oblique edge 18b, The angle δ of the outward oblique edge 18b is larger than the chamfering angle β, The chamfering angle β may be, for example, between 20 and 40°, and the angled of the outward oblique edge 18b may be, for example, 40 to 70°. It is also possible to form, if so desired, an inward oblique edge at the end of the formed part, that is, plate part. 17, whose angle would be larger than that of the rest of the formed part. By means of the outward oblique edge and/or inward oblique edge, the alignment of the device to the end of the pipe 1 being machined is facilitated.

In the embodiments shown in FIGS. 2 to 6 and 11, the device 5 is adapted for handling a pipe of a particular size. Chamfering means and formed parts for handling two (or more) pipes of different diameters may also be adapted in the device 5. In such a case, the distance of the parts of the outer formed parts, intended for preparing the larger diameter and settling on the inner edge of the pipe being prepared, naturally needs to be larger from the centre point of the body than the outer diameter of the smaller pipe.

In the embodiments shown in FIGS. 7 to 10 and 12, the device 5 has means for preparing two pipes with different diameters. The plate parts 17 form the formed parts settling on the inner surface of the pipe smaller in diameter. The plate parts 18 form the chamfering means intended for chamfering the pipe with the larger diameter. In connection with each plate part 17 and 18, there is further an intermediate part 27 formed of a plate. The intermediate parts 27 form both the formed parts settling on the inner surface of the pipe larger in diameter and the chamfering means intended to chamfer the pipe with the smaller diameter. An outer edge 28 of the intermediate part 27 settles, when the device 5 is used, on the inner surface of the pipe larger in diameter, and the machining edge 18a of the plate part 18 forms a chamfer at the end of the pipe. Correspondingly, an outer edge 17a of the plate part 17 settles, when the device 5 is used, on the inner surface of the pipe smaller in diameter, and the inner edge 29 of the intermediate part 27 is the machining edge that forms a chamfer at the end of the pipe.

In the embodiments according to FIGS. 5 to 12, the device 5 has the same number of chamfering means and formed parts. Such a device is simple, reliable, durable and easy to accomplish.

In the embodiment of FIG. 10, the chamfering means, that is, the plate part 18, has a machining edge 18a at a chamfering angle β. In addition, the plate part 18 has at its end an outward oblique edge 18b. The angle δ of the outward oblique edge 18b is larger than the chamfering angle β. In the embodiment of FIG. 10, the plate part 17 further has at its end an inward oblique edge 17b whose angle γ is larger than that of the rest of the formed part. The intermediate part 27 also has oblique edges that are similarly formed.

FIG. 12 shows yet another embodiment of the device 5, The embodiment of FIG. 12 has similar means to attach the body part 6 to the adapter as the embodiment of FIG. 11. Further, the embodiment of FIG. 12 has similar chamfering means and formed parts as the embodiment of FIG. 10.

If desired, two (or more) devices 5 formed for pipes of different sizes may be adapted one on the other to a tool such as a drill. In this case, when pipes of different sizes are prepared, there is no need to switch a different device 5 to the tool.

The distance between the chamfering means and formed part is chosen based on how large a wall thickness the pipe 1 to be chamfered has. The distance is additionally affected by how sharp the chamfered end is to be.

The chamfering means may be of metal, for example. The chamfering means may also be of another material, as long as the material of the chamfering means is harder than the material of the pipe 1 being chamfered.

The structure of the device 5 may also be one where it has a funnel-shaped body part on the inner surface of which the chamfering means are adapted. In addition, a protective shell or protective casing may be installed in the device, or the protective cup 22 shown in FIG. 13 on the outside of the chamfering means to protect the user from injuries or accidents. The protective cup 22 may have a rear plate 23 against which the body part 6 of the device 5 may be placed. The rear plate 23 may have a centre hole 24 through which the centre bolt of the adapter may be adapted. The protective cup 22 may further have a cylinder part 25 facing forward from the rear plate.

Those skilled in the art will find it obvious that, as technology advances, the basic idea of the invention may be implemented in many different ways. The invention and its embodiments are thus not restricted to the examples described above but may vary within the scope of the claims.

1. A device for chamfering a pipe end, the device comprising
a body part,
in the body part, means for fastening it to an adapter to be placed in a chuck of a handheld drill,
at least two formed parts facing forward from the body part, which are adaptable to settle inside a pipe to be chamfered, and
on the outer rim of the body part, chamfering means for chamfering an outer edge of an end of the pipe.

2. A device as claimed in claim 1, wherein the chamfering means are plate parts bent forward from a plate-like body blank.

3. A device as claimed in claim 1 wherein the formed parts are plate parts bent forward from a plate-like body blank.

4. A device as claimed in claim 1, wherein the chamfering means have a machining edge at a chamfering angle, and at the end of the chamfering means, outward at an angle greater than the chamfering angle, an edge.

5. A device as claimed in claim 1, wherein the formed part has at its end an inward oblique edge, whose angle is greater than that of the remaining part of the formed part.

6. A device as claimed in claim 1, wherein the chamfering means are adapted in a rearward slanting position in relation to a direction of rotation.

7. A device as claimed in claim 6, wherein the chamfering means are at angle of 30 to 89°, advantageously 60 to 70°, in relation to the body part.

8. A device as claimed in claim 1, wherein between the formed part and chamfering means there is a smoothing surface adapted to clean and smooth out the front edge of the pipe being chamfered.

9. A device as claimed in claim 1, wherein the body part has at least three, advantageously at least four, formed parts facing forward from the body part, which are adaptable to settle inside the pipe being chamfered.

10. A device as claimed in claim 1, wherein the formed parts are so formed that when the device is being used they are adapted to remove burrs from the end of the pipe.

11. A device as claimed in claim 1, wherein the device has the same number of chamfering means and formed parts.

12. A device as claimed in claim 1, wherein the device has chamfering means at two distances, at least, from the centre of rotation, and similarly, formed parts at two distances, at least, inside each chamfering means whereby the device is adapted to be used for chamfering ends of at least two pipes having different diameters.

13. A device as claimed in claim 12, wherein the chamfering means and formed parts are plate parts bent forward from a plate-like body blank so that the inner chamfering means are of the same structure as the outer formed part.

14. A device as claimed in claim 1, wherein the means for fastening the body part to an adapter placed in a chuck of a handheld drill comprise a centre hole of the body part, and in connection with the centre hole a threaded part provided with an inside thread.

15. A device as claimed in claim 2, wherein the formed parts are plate parts bent forward from a plate-like body blank.
